(19) United States
(12) Patent Application Publication
(10) Pub. No.: US 2023/0386694 A1
(43) Pub. Date: Nov. 30, 2023

(54) METHOD FOR MANUFACTURING A RADIATION WINDOW WITH AN EDGE STRENGTHENING STRUCTURE AND A RADIATION WINDOW WITH AN EDGE STRENGTHENING STRUCTURE

(71) Applicant: AMETEK FINLAND OY, Espoo (FI)

(72) Inventors: Pekka TÖRMÄ, Helsinki (FI); Esa KOSTAMO, Helsinki (FI); Jari KOSTAMO, Espoo (FI); Tapio LANTELA, Espoo (FI)

(73) Assignee: AMETEK FINLAND OY, Espoo (FI)

(21) Appl. No.: 18/322,044

(22) Filed: May 23, 2023

(30) Foreign Application Priority Data
May 24, 2022 (FI) 20225453

(51) Int. Cl. G21K 1/00

(52) U.S. Cl. CPC G21K 1/00

(57) ABSTRACT

A method is for manufacturing a radiation window for an X-ray measurement apparatus. The method includes producing an etch stop layer on a surface of a carrier and producing a foil structure on a side of the etch stop layer opposite the carrier. A combined structure with the etch stop layer and the foil structure is attached to a region around an opening in a housing of the X-ray measurement apparatus with the foil structure facing the housing so that an edge strengthening structure is arranged between the combined structure and an edge region around the opening in the housing or partly inside the foil structure. At least part of the carrier is detached before attaching the combined structure or detaching at least part of the carrier after attaching the combined structure, wherein the combined structure includes the carrier. A radiation window is for an X-ray measurement apparatus.

### CROSS-REFERENCE TO RELATED APPLICATION

This U.S. patent application claims the benefit of Finnish Patent Application No. 20225453 filed with the Finnish Patent Office on May 24, 2022, the entire contents of which is incorporated herein by reference.

### TECHNICAL FIELD

The invention concerns in general the technology of thin foils that are used as such or as a part of a radiation window in a measurement apparatus. Especially the invention concerns a method for manufacturing a radiation window with an edge strengthening structure for an X-ray measurement apparatus, and a radiation window with an edge strengthening structure for an X-ray measurement apparatus manufactured with such method.

### BACKGROUND OF THE INVENTION

A radiation window is a part of a measurement apparatus that allows a desired part of electromagnetic radiation to pass through. In many cases the radiation window must nevertheless be gastight, in order to seal and protect an enclosure where reduced pressure and/or a particular gas contents prevail. In order to cause as little absorption as possible of the desired radiation, a major part of the radiation window should consist of a thin foil made from materials preferably comprising only elements with small atomic number. The radiation window foil may be attached to a housing of the radiation window by a selected joining method including for example glueing or soldering.

However, the thin radiation window foil structure with a thickness in the scale from few tens of nanometers to few micrometers is extremely sensitive when it is mounted on the housing of the measurement apparatus due to various factors. For example, there may be different thermal expansion coefficients between the housing and the radiation window foil material(s), the surface of the housing may be non-ideal (e.g. because of a mechanical roughness), and/or the joining method between the housing and the radiation window foil may have a non-perfect compatibly on either of the surfaces or materials. Typically, an atmospheric level differential pressure may be applied over the radiation window foil in operation. This may cause a constant stress over the thin radiation window foil. The stress may be locally increased on a part of the thin radiation window foil, for example because of the non-idealities described above, leading to a breakage of the thin radiation window foil. For example, the thin radiation window foil may break, when the radiation window foil is pressed against a sharp and/or uneven edge of the housing.

Typically, mechanical properties of different types of thin radiation window foils may be sufficient to be used in the radiation windows. However, the used joining method may cause the decrease of the strength of the thin radiation window foil.

Thus, there is a need to mitigate the mentioned problems and develop a solution for providing additional strength for a thin radiation window foil attached on a housing of a radiation window.

### SUMMARY OF THE INVENTION

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a radiation window and a method for manufacturing a radiation window for an X-ray measurement apparatus. Another objective of the invention is that the radiation window and the method for manufacturing a radiation window enable providing a radiation window with a window foil that is thin, absorbs very little X-rays, and has good tensile strength also when mounted on a housing of the radiation window.

The objectives of the invention are reached by a method and a radiation window as defined by the respective independent claims.

According to a first aspect, a method for manufacturing a radiation window for an X-ray measurement apparatus is provided, wherein the method comprises: producing an etch stop layer on a surface of a carrier; producing a foil structure on an opposite side of the etch stop layer than the carrier, wherein the foil structure comprises at least one thin film layer; and attaching a combined structure comprising at least the etch stop layer and the foil structure to a region around an opening in a housing with the foil structure facing the housing so that an edge strengthening structure is arranged between the combined structure and an edge region around the opening in the housing or at least partly inside the foil structure, wherein method further comprises: detaching at least part of the carrier before attaching the combined structure; or detaching at least part of the carrier after attaching the combined structure, wherein the combined structure further comprises the carrier.

The edge strengthening structure may be made of one or more of the following: a photo definable material, a polymer material, a polymer-based adhesive, a tape-based material, a 3D printable plastic, or a metal.

The strengthening structure may be arranged so that the edge strengthening structure overlaps with the opening.

The arranging the edge strengthening structure between the combined structure and the edge region around the opening in the housing may comprise producing the edge strengthening structure: on an opposite side of the foil structure than the etch stop layer, or on the edge region around the opening in the housing.

The at least one thin film layer of the foil structure may be made of one of the following: boron carbide, graphene, beryllium, polyimide, silicon nitride, or polycrystalline silicon.

The foil structure may further comprise at least one radiation filtering layer.

The method may further comprise producing an additional radiation filtering layer at least on the exposed etch stop layer after the detaching the at least part of the carrier.

According to a second aspect, a radiation window for an X-ray measurement apparatus is provided, wherein the radiation window comprises: a housing that defines an opening; a radiation window foil attached to the housing at a region around the opening to cover the opening of the housing, wherein the radiation window foil comprises: a foil structure comprising at least one thin film layer, wherein the foil structure is facing the housing, and an etch stop layer on an opposite side of the foil structure than the housing; and an edge strengthening structure arranged between the radiation window foil and an edge region around the opening in the housing or at least partly inside the foil structure.

The edge strengthening structure may be made of one or more of the following: a photo definable material, a polymer material, a polymer-based adhesive, a tape-based material, a 3D printable plastic, or a metal.

The edge strengthening structure may overlap with the opening.

The radiation window may further comprise an additional support structure on an opposite side of the etch stop layer than the foil structure.

The at least one thin film layer of the foil structure may be made of one of the following: boron carbide, graphene, beryllium, polyimide, silicon nitride, or polycrystalline silicon.

The foil structure may further comprise at least one radiation filtering layer. Alternatively or in addition, the radiation window may further comprise an additional radiation filtering layer on an opposite side of the etch stop layer than the foil structure.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of a method and a radiation window.

FIGS. 2A and 2B illustrate schematically examples of a foil structure.

FIG. 2C illustrates an example of an annular region around an opening in a housing to which a combined structure may be attached.

FIG. 2D illustrates an example of an annular edge region around an opening in a housing.

FIG. 3 illustrates schematically another example of a method and a radiation window.

FIGS. 4A-4F illustrate schematically examples of producing processes for producing an edge strengthening structure of a radiation window.

FIG. 5A illustrates schematically an example of a workpiece on which a plurality of edge strengthening structures are produced.

FIG. 5B illustrates schematically an example of a single piece on which an edge strengthening structure is produced.

FIG. 6 illustrates schematically yet another example of a method and a radiation window.

### DETAILED DESCRIPTION OF THE EMBODIMENTS

In this description we use the following vocabulary. A layer means a quantity of essentially homogeneous material that by its form has much larger dimensions in two mutually orthogonal directions than in the third orthogonal direction. In most cases of interest to the present invention, the dimension of a layer in said third orthogonal direction (also referred to as the thickness of the layer) should be constant, meaning that the layer has uniform thickness. A foil is a structure, the form of which may be characterised in the same way as that of a layer (i.e. much larger dimensions in two mutually orthogonal directions than in the third orthogonal direction) but which is not necessarily homogeneous: for example, a foil may consist of two or more layers placed and/or attached together. A radiation window foil 110 is a foil that has suitable characteristics (low absorption of desired radiation, sufficient gastightness, sufficient mechanical strength etc.) for use in a radiation window 100 of a measurement apparatus, e.g. an X-ray measurement apparatus. A radiation window 100 is an entity that comprises a piece of radiation window foil 110 attached to an annular housing (i.e. a support structure) 105 so that electromagnetic radiation may pass through an opening 104 defined by the housing 105 without having to penetrate anything else than said piece of radiation window foil 110.

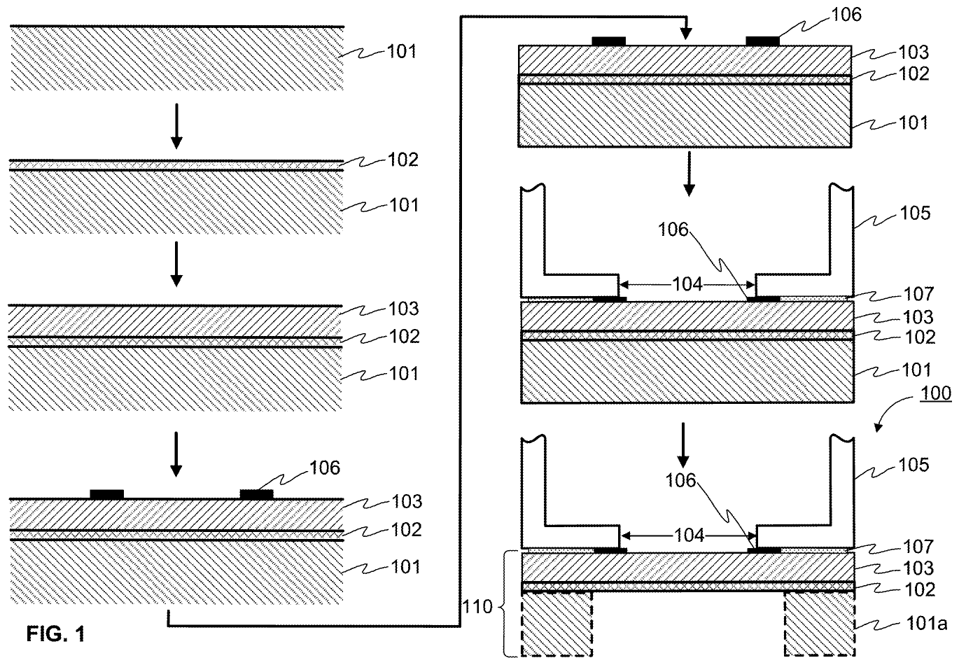

FIG. 1 illustrates an example of a workpiece in various steps of an example method for manufacturing a radiation window 100 with an edge strengthening structure 106 for an X-ray measurement apparatus. FIG. 1 illustrates a cross-sectional view of the workpiece in the various steps of the example method. The measurement apparatus may for example be, but is not limited to, an X-ray fluorescence (XRF) spectrometer or a radiation detector. The topmost step illustrates a carrier 101, at least one surface of which has been polished. In FIG. 1, the polished surface faces upwards. The required smoothness of the polished surface is determined by the aim of covering it with an essentially continuous etch stop layer with uniform thickness in the order of to 200 nanometres. The carrier 101 may be a silicon wafer. As an example, silicon wafers are routinely polished to achieve rms (root mean square) roughness values in the order of fractions of a nanometre, which is a sufficient for the purposes of the present invention. In addition or as alternative to silicon, the carrier 101 may be manufactured from some other solid material that can be polished to the required level of smoothness and that is preferably etchable with some reasonably common and easily handled etching agent.

In the next step of the example method an etch stop layer 102 is produced on the polished surface of the carrier 101. The main objective of the etch stop layer 102 is to provide gastight radiation window foil 110. Additionally, the objective of the etch stop layer 102 is to keep an etching agent, which in a later method step will appear from below and remove at least part of the carrier 101, from affecting those layers that come on top of the etch stop layer 102, i.e. the material of the etch stop layer 102 is impervious for the etching agent. Therefore, the material for the etch stop layer 102 should be selected so that it will not be affected to any significant degree by an etching agent that works effectively on the material of the carrier 101. Additionally, the material of the etch stop layer 102 should be applicable for deposition in thin layers (in the order of 5 to 200 nanometres), and it should neither significantly absorb radiation nor produce any awkwardly handled anomalities at the wavelengths of electromagnetic radiation at which the radiation window 100 is to be used. Further advantageous characteristics of an etch stop layer 102 include corrosion resistance against environmental conditions during the use of the X-ray measurement apparatus, and good adhesion properties for further layers to be deposited thereon. For example, if the carrier 101 is made of silicon, one advantageous material for the etch stop layer 102 is silicon nitride. Alternatively, other advantageous materials for the etch stop layer 102 may for example be, but are not limited to, aluminium oxide and silicon dioxide. The deposition of the etch stop layer 102 should take place as uniformly as possible, especially avoiding any remaining pinholes in the etch stop layer 102. Suitable methods for depositing the etch stop layer 102 include, but are not limited to, chemical vapour deposition, pulsed laser deposition, and atomic layer deposition. We may note that the illustrated dimensions in the drawings are not to scale and not comparable to each other; they have been selected only for graphical clarity in the drawings.

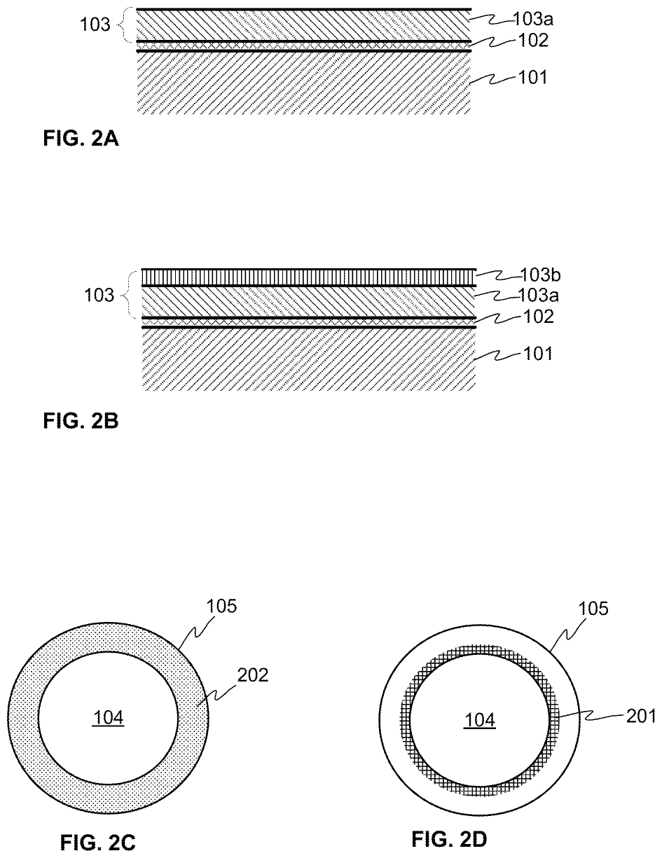

In the next step of the example method illustrated in FIG. 1 a foil structure 103 is produced on an opposite side of the etch stop layer 102 than the carrier 101. The foil structure 103 may comprise at least one thin film layer 103a. FIG. 2A illustrates an example of the foil structure 103 produced on the opposite side of the etch stop layer 102 than the carrier 101, wherein the foil structure 103 comprises one thin film layer 103a. FIG. 2A illustrates a cross-sectional view of the workpiece in the example step of producing the foil structure 103. The at least one thin film layer 103a of the foil structure 103 may for example be made of one of the following: boron carbide, graphene, beryllium, polyimide, silicon nitride, or polycrystalline silicon. The at least one thin film layer 103a may provide mechanical strength for the foil structure 103 and thus also for the completed radiation window 100. The thickness of the at least one thin film layer 103a may for example be between 0.25 to 5 micrometres, preferably the thickness of the at least one thin film layer 103a may for example be between 1 to 3 micrometres. If the at least one thin film layer 103a was thinner, its mechanical strength would be so low that the need for additional support solutions could easily mitigate the positive effects of the present invention. Alternatively, if the at least one thin film layer 103a was thicker, its absorption might come too high concerning very sensitive X-ray measurements, such as a detection of sodium. Alternatively or in addition, the at least one thin film layer 103a may preferably be made as even and as pinhole-free as possible. Suitable methods for producing the at least one thin film layer 103a may include, but are not limited to, sputtering, plasma assisted chemical vapour deposition, and pulsed laser deposition. The foil structure 103 may further comprise at least one radiation filtering layer 103b. The at least one radiation filtering layer 103b may for example be, but is not limited to, made of aluminium zirconium, niobium, or silver. FIG. 2B illustrates an example of the foil structure 103 produced on the opposite side of the etch stop layer 102 than the carrier 101, wherein the foil structure 103 comprises further one radiation filtering layer 103b, i.e. the foil structure 103 comprises one thin film layer 103a and one radiation filtering layer 103b. FIG. 2B illustrates a cross-sectional view of the workpiece in the example step of producing the foil structure 103. In the example of FIG. 2B the thin film layer 103a is produced on the opposite side of the etch stop layer 102 than the carrier 101 and the radiation filtering layer 103b is produced on an opposite side of the thin film layer 103a than etch stop layer 102. However, the invention is not limited to that and the light attenuator layer 103b may also be produced on the opposite side of the etch stop layer 102 than the carrier 101 and the thin film layer 103a may be produced an opposite side of the radiation filtering layer 103b than etch stop layer 102. If the foil structure 103 comprises more than one thin film layer 103a and/or more than one radiation filtering layer 103b (i.e. the foil structure 103 is a multilayer structure), the foil structure 103 may be produced so that every other layer of the foil structure 103 is a thin film layer 103a and every other layer of the foil structure 103 is a radiation filtering layer 103b The at least one radiation filtering layer 103b has a role in blocking out unwanted wavelengths of electromagnetic radiation, such as ultraviolet (UV) radiation, visible light (VIS), and/or infrared (IR) radiation, etc. The thickness of the at least one radiation filtering layer 103b may for example be between 10 to 300 nanometres, preferably the thickness of the at least one radiation filtering layer 103b may for example be between 120 to 250 nanometres. The thickness of the at least one radiation filtering layer 103b may depend on the application and/or an operation environment of the application. For example, the thickness of a radiation filtering layer 103b made of aluminium may preferably be between 120 to 250 nanometres in applications used in daylight.

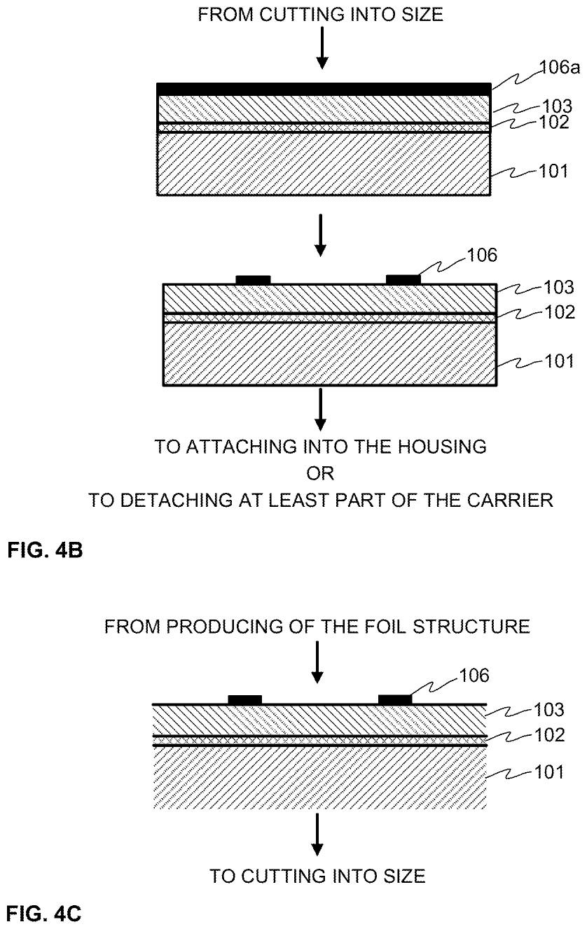

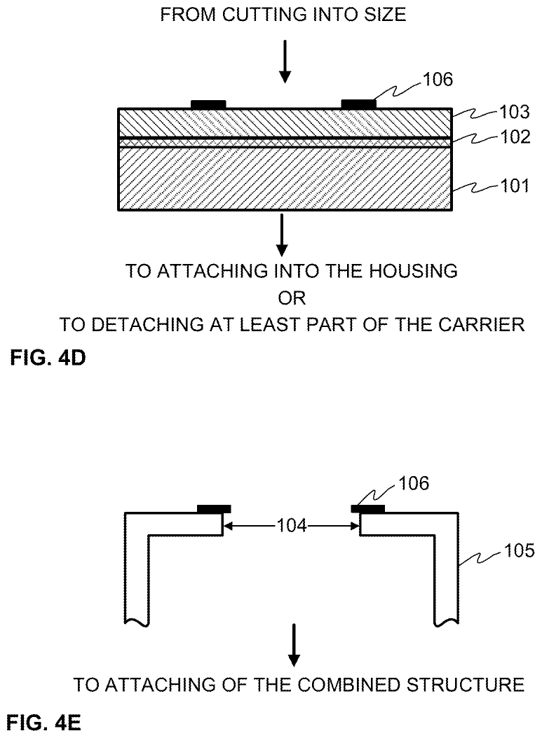

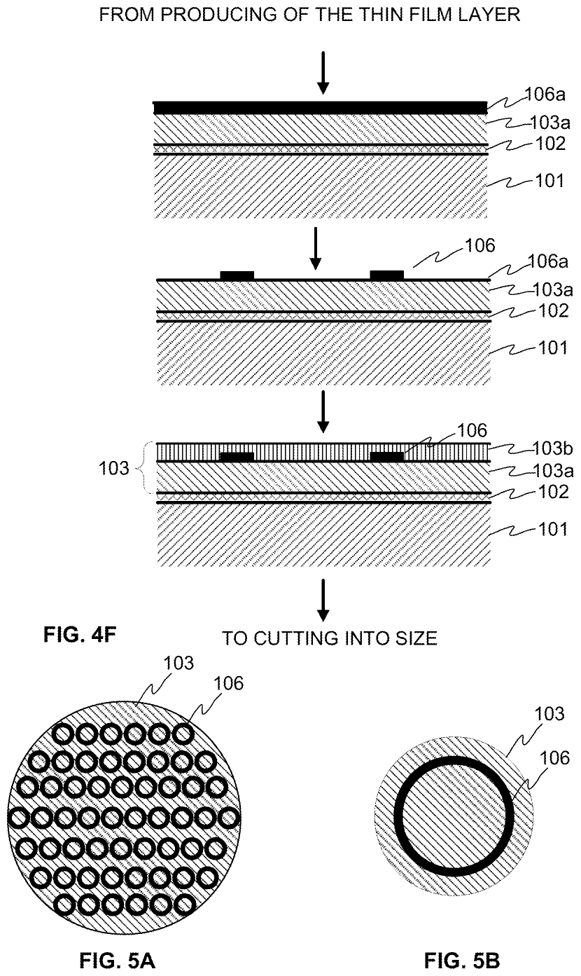

In the next step of the example method illustrated in FIG. 1 an annular edge strengthening structure 106 is produced. According to an example, the edge strengthening structure 106 may be produced on an opposite side of the foil structure 103 than the etch stop layer 102 as illustrated in the example of FIG. 1. According to another example, the edge strengthening structure 106 may be produced at least partly inside the foil structure 103 as will be described later for example by referring to FIG. 4F. According to yet another example, the edge strengthening structure 106 may be produced on an edge region 201 around an opening 104 in a housing 105 of the radiation window 100 as will be described later for example by referring to FIG. 4E. The edge strengthening structure 106 may be made of one or more of the following: a photo definable material (e.g. HD-4100 series polyimide, SU-8 photoresist, or AZ4500 series photoresist, etc.), a polymer material, a polymer-based adhesive, a tape-based material (e.g. Kapton tape or dicing tape, etc.), a 3D printable plastic, or a metal (e.g. aluminium, indium, nickel, or niobium, etc.). The thickness of the edge strengthening structure 106 may for example be between 2 to 30 micrometres, preferably the thickness of the edge strengthening structure 106 may for example be between 10 to 20 micrometres. An inner diameter of the edge strengthening structure 106 may for example be defined based on a diameter of the opening 104 of the housing 105. Preferably, the inner diameter of the edge strengthening structure 106 may be smaller than the diameter of the opening 104 of the housing 105. This enables that the edge strengthening structure 106 overlaps with the opening 104, when the radiation window foil 110 is attached to the housing 105 as will be described later in this description. For example, the inner diameter of the strengthening structure 106 may be a slightly smaller than the diameter of the opening 104 of the housing 105. An outer diameter of the strengthening structure 106 may be defined so that the strengthening structure 106 covers at least some region (i.e. the edge region 201) around the opening 104 in the housing 105. The upper limit for the outer diameter of the strengthening structure 106 may for example be defined by a diameter of the completed radiation window 100 (i.e. the diameter of a completed radiation window chip). According to a non-limiting example, if the diameter of the opening 104 of the housing 105 is 6.5 millimetres, the inner diameter of the strengthening structure 106 may for example be 6 millimetres and the outer diameter of the strengthening structure 106 may for example be 7.6 millimetres. The edge strengthening structure 106 may comprise one or more layers. According to a non-limiting example, the edge strengthening structure 106 may for example comprise a first layer made of a first material (e.g. a first photo definable material, such as HD-4100 series polyimide) and a second layer may of a second material (e.g. a second photo definable material, such as SU-8 photoresist). The edge strengthening structure 106 may be produced by using several producing methods. At least some of the producing methods of the edge strengthening structure 106 may depend on the material of the edge strengthening structure 106. Some examples of the producing processes (i.e. the producing methods) for producing the edge strengthening structure 106 are discussed later in this description by referring to FIGS. 4A-4F.

According to an example, in the next step of the example method illustrated in FIG. 1 a combined structure comprising at least the carrier 101, the etch stop layer 102, and the foil structure 103 may be cut into pieces, so that a single piece (e.g. a single chip) is suitably sized for use in one radiation window 100. As an example, the carrier 101 might have originally been a silicon wafer with a diameter of several inches, while the diameter of a piece sufficient for a radiation window 100 may for example be between 1 and 2 centimetres. On the other hand, the invention does not limit the maximum size of a radiation window 100 to be made. As another example, a radiation window 100 according to an example might have 50 millimetres as the diameter of the foil-covered opening 104 for the radiation to pass through. Cutting the combined structure into pieces at this step of the method is not an essential requirement of the manufacturing method, but it is advantageous in the sense that a larger number of completed radiation windows 100 can be very practically manufactured from a single original workpiece. In the example of FIG. 1 the combined structure is cut into the pieces after the step of producing the edge strengthening structure 106, but the combined structure may be cut into the pieces also at other points of the method as will be described later in this description. At this cutting step of the example of FIG. 1, the combined structure comprises the carrier 101, the etch stop layer 102, the foil structure 103, and the edge strengthening structure 106.

In the next step of the example method illustrated in FIG. 1 the piece of the combined structure comprising at least the etch stop layer 102 and the foil structure 103 is attached (i.e. joined) to an annular region 202 around the opening 104 in the housing 105 (i.e. the support structure) of the radiation window 100 with the foil structure 103 facing the housing 105. The material of the housing 105 may be for example, but is not limited to, kovar, nickel, zirconium or stainless steel. The combined structure is attached to the annular region 202 around the opening 104 in the housing 105 by using an edge strengthened attachment process. In other words, the attachment of the combined structure to the housing 105 is performed so that the edge strengthening structure 106 is arranged between the combined structure and the annular edge region 201 around the opening 104 in the housing 105 or at least partly inside the foil structure 103. The edge strengthening structure 106 strengthens the completed radiation window foil 110 at least at the edge region 201 around the opening 104 in the housing 105, when the radiation window foil 110 is attached to the housing 105. The edge strengthening structure 106 may preferably be arranged so that the edge strengthening structure 106 overlaps with the opening 104. In other words, after the attachment a part of the edge strengthening structure 106 overlaps with the opening 104 of the housing 105. For example, in the example of FIG. 1 a part of the edge strengthening structure 106 overlaps with the opening 104 of the housing 105 and the rest of the edge strengthening structure 106 resides between the combined structure and the annular edge region 201 around the opening 104 in the housing 105. The producing of the edge strengthening structure 106 so that it overlaps with the opening 104 improves the effect of the edge strengthening structure 106. The annular edge region 201 around the opening 104 in the housing 105 may overlap at least partly with the annular region 202 around the opening 104 in the housing 105 to which the combined structure is attached. FIG. 2C illustrates a non-limiting example of the annular region 202 around the opening 104 in the housing 105 to which the combined structure may be attached. FIG. 2C illustrates a top view of the housing 105. FIG. 2D, in turn, illustrates a non-limiting example of the annular edge region 201 around the opening 104 in the housing 105. FIG. 2D illustrates a top view of the housing 105. The width of the annular edge region 201 depends on the outer diameter of the edge strengthening structure 106, but the annular edge region 201 starts from the edge of the housing 105 that is limited by the opening 104. The at least partly overlapping of the annular edge region 201 with the annular region 202 may be seen in FIGS. 2C and 2D. The edge strengthening structure 106 distributes a possible point stress on the completed radiation window foil 110 attached to the housing 105 of the radiation window 100 caused for example by a sharp object on the housing 105 or any other non-idealities to a wider area on the radiation window foil 110 preventing or at least reducing the breakage of the radiation window foil 110. Thus, the edge strengthening structure 106 improves the strength of the completed radiation window foil 110 attached to the housing 105.

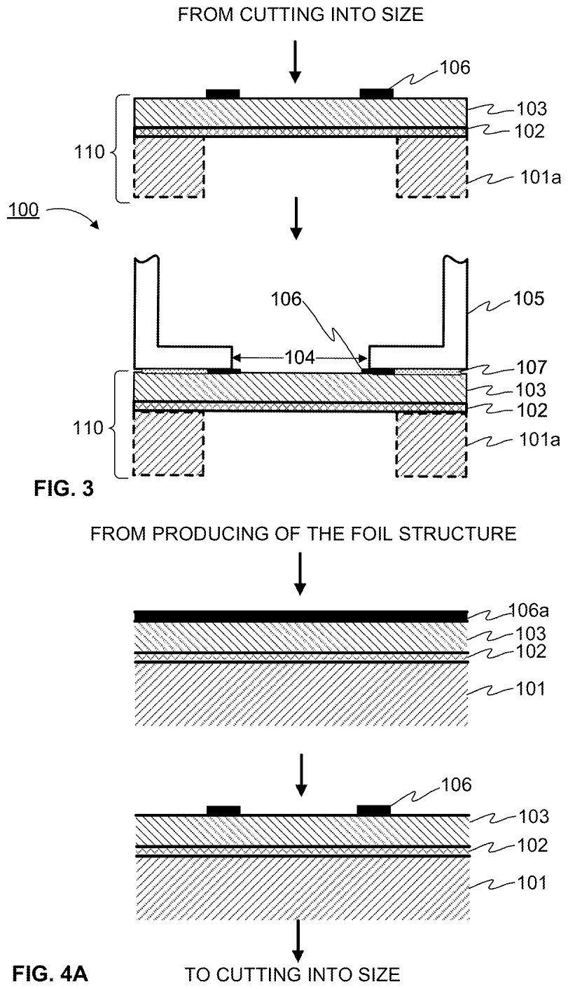

For the attachment of the combined structure to the housing structure 105 for example soldering or glueing may be used. The solder material used in the soldering may for example be indium. The adhesive material used in the glueing may for example be epoxy. The cross-section of an exaggeratedly thick layer of glue or solder 107 is schematically shown in FIG. 1. The illustration of the glue or solder 107 is only schematic in FIG. 1, and it does not mean that a flat layer of glue or solder on the planar surface between the housing 105 and the foil structure 103 would be the only possible alternative. In the example of FIG. 1 the combined structure comprises further the carrier 101, but at least part of the carrier 101 may alternatively be detached before attaching the combined structure to the housing 105 as will be described later for example by referring to the example of FIG. 3. The fact that the carrier 101 is still present at the step of attaching the combined structure to the housing 105 enable that the handling is easy and there is no need to worry about wrinkling or other kinds of deformation of the radiation window foil 110 at this stage.

The descriptor “annular” should be understood in a wide sense. The invention does not require the annular housing 105, and/or the annular edge strengthening structure 106 to have e.g. a circular form. For example, it is sufficient that the housing structure 105 offers some edges and/or region around the opening 104, to which the radiation window foil 110 may be attached tightly and extensively enough to keep the radiation window foil 110 in the completed structure securely in place, and—in those applications where gastightness is required—to form a gastight seal.

In the last step illustrated in the example of FIG. 1 at least part of the carrier 101 is detached. If the carrier 101 is completely detached, the radiation window foil 110 comprising at least the etch stop layer 102 and the foil structure 103 is left to cover the opening 104 of the housing 105. Alternatively, if the carrier 101 is partly detached, the radiation window foil 110 covering the opening of the housing 105 may further comprise an annular additional support structure 101a formed by the remaining part of the carrier 101. The additional support structure 101a does not disturb the desired part of electromagnetic radiation to pass through the radiation window 100 or cause more unwanted absorption or spurious responses, because the additional support structure 101a does not extend to the middle of the radiation window 100, wherein the opening 104 in the housing 105 resides. The annular additional support structure 101a is illustrated in FIG. 1 with the dashed lines to indicate that the carrier 101 may be detached either partly or completely. Alternatively or in addition, the radiation window foil 110 may further comprise the edge strengthening structure 106 depending on the producing process of the edge strengthening structure 106. The detaching of the at least part of the carrier 101 may for example comprise etching away the at least part of the carrier 101. Alternatively, other methods may be used for detaching the at least part of the carrier 101. Etching is considered to be the most advantageous way of carefully removing the carrier 101 while leaving the other layers intact. As an example, if the carrier 101 is made of silicon and the gas diffusion stop layer 102 is made of silicon nitride, potassium hydroxide (KOH) is one suitable etching agent, especially at a slightly elevated temperature like 70 to 90 degrees centigrade. In the etching stage it should be ensured that the etching agent only affects the side of the radiation window foil where the etch stop layer 102 exists. In the example of FIG. 1 the carrier 101 is detached, e.g. etched away, after attaching the combined structure to the region 202 around the opening 104 in the housing 105. In other words, in the example of FIG. 1 the combined structure attached to the housing 105 further comprises the carrier 101, i.e. the combined structure comprises at least the carrier 101, the etch stop layer 102, the foil structure 103, and the etch strengthening structure 106. However, the invention is not limited to this and the at least part of the carrier 101 may also be detached (e.g. etched away) before attaching the combined structure to the region 202 around the opening 104 in the housing structure 105. An example of this is illustrated in FIG. 3, wherein the method otherwise corresponds to the example of FIG. 1, but the at least part of the carrier 101 is detached before the attaching the combined structure to the region 202 around the opening 104 in the housing 105 and the combined structure, i.e. the radiation window foil 110 in this example, comprising at least the etch stop layer 102 and the foil structure 103 and possibly also the additional support structure 101a formed by the remaining part of the carrier 101 and/or the edge strengthening structure 106 is then attacked to the region 202 around the opening 104 in the housing 105. The annular additional support structure 101a is illustrated in FIG. 3 with the dashed lines to indicate that the carrier 101 may be detached either partly or completely.

After the above-described method steps, post-processing steps such as rinsing, drying, and testing may be applied according to need. The manufactured radiation window 100 may be attached to the X-ray measurement apparatus.

As mentioned above FIGS. 4A-4F illustrate some examples of the producing processes for producing the edge strengthening structure 106. FIGS. 4A-4F illustrate a cross-sectional view of the workpiece in the various steps of the example producing processes for producing the edge strengthening structure 106. In the example of FIG. 4A the edge strengthening structure 106 may be produced on the opposite side of the foil structure 103 than the etch stop layer 102 after the step of producing the foil structure 103 on the etch stop layer 102 as discussed above. In this example the producing process of the edge strengthening structure 106 may comprise depositing a strengthening film 106a on the opposite side of the foil structure 103 than the etch stop layer 102. The strengthening film 106a may for example be deposited for example by spinning, spraying, printing, or dispensing, etc. In the next step of the example of FIG. 4A the strengthening film 106a may be patterned to produce the annular shape of the edge strengthening structure 106. The patterning of the strengthening film 106a may for example be performed by using lithography (e.g. UV lithography), or selective etching (e.g. plasma etch-dry etching or wet etching), etc. depending on the material of the edge strengthening structure 106. The example producing process of FIG. 4A may preferably be suitable for example for the edge strengthening structure 106 made of the photo definable material, the polymer material, or metal (e.g. aluminium, indium, nickel, or niobium, etc.). For example, if the edge strengthening structure 106 is made of photo definable material, the patterning of the strengthening film 106a may be performed by using lithography (e.g. UV lithography). Otherwise, the selective etching may for example be used for patterning the strengthening film 106a. If the edge strengthening structure 106 is made of metal, the edge strengthening structure 106 may also be produced by using galvanic growth. In this example after the producing the edge strengthening structure 106, the manufacturing method may continue to the cutting step, where the combined structure comprising at least the carrier 101, the etch stop layer 102, the foil structure 103, and the edge strengthening structures 106 may be cut into the pieces as discussed above. Producing the edge strengthening structure 106 before the cutting step enables that a larger number of completed radiation windows 100 with the edge strengthening structure 106 may be practically manufactured at once. FIG. 5A illustrates a non-limiting example of the workpiece on which a plurality of edge strengthening structures 106 are produced (for a respective plurality of completed radiation windows 100) on the opposite side of the foil structure 103 than the etch stop layer 102. FIG. 5A illustrates a top view of the workpiece, i.e. the surface of the foil structure 103 on which the plurality of edge strengthening structures 106 are produced. For sake of clarity only one edge strengthening structure 106 is referred with the reference sign 106 in the example of FIG. 5A, but all the other corresponding annular structures in FIG. 5A are also edge strengthening structures 106.

FIG. 4B illustrates another example of producing the edge strengthening structure 106. In the example of FIG. 4B the edge strengthening structure 106 may be produced on a single piece (i.e. a single chip) on the opposite side of the foil structure 103 than the etch stop layer 102 after cutting the combined structure comprising the carrier 101, the etch stop layer 102, and the foil structure 103 into the pieces. The producing process of the edge strengthening structure 106 according to the example of FIG. 4B corresponds otherwise to the producing process of the edge strengthening structure 106 according to the example of FIG. 4A, but the edge strengthening structure 106 is produced on the single chip after the cutting step. FIG. 5B illustrates a non-limiting example of a single piece (e.g. a single chip) on which the edge strengthening structure 106 is produced on the opposite side of the foil structure 103 than the etch stop layer 102. FIG. 5B illustrates a top view of the single piece, i.e. the surface of the foil structure 103 on which the edge strengthening structure 106 is produced. In this example after the producing the edge strengthening structure 106, the manufacturing method may continue to the attaching step, where the combined structure comprising the carrier 101, the etch stop layer 102, the foil structure 103, and the edge strengthening structure 106 is attached to the housing 105 as discussed above. Alternatively, the at least part of the carrier 101 may be detached (e.g. etched away) before attaching the combined structure, i.e. the radiation window foil 110 in this example, comprising at least the etch stop layer 102, the foil structure 103, and the edge strengthening structure 106 and possibly also the additional support structure 101a formed by the remaining part of the carrier 101 to the region 202 around the opening 104 in the housing 105.

FIG. 4C illustrates yet another example of producing the edge strengthening structure 106. In the example of FIG. 4C the edge strengthening structure 106 may be produced on the opposite side of the foil structure 103 than the etch stop layer 102 after producing the foil structure 103 on the etch stop layer 102 as discussed above. In this example the producing of the edge strengthening structure 106 may comprise dispensing the edge strengthening structure 106 on the opposite side of the foil structure 103 than the etch stop layer 102. According to an example, a pre shaped annular edge strengthening structure 106 may be dispensed on the opposite side of the foil structure 103 than the etch stop layer 102. According to another example, the annular edge strengthening structure 106 may be shaped on the opposite side of the foil structure 103 than the etch stop layer 102 during the dispensing. The example producing process of FIG. 4C may preferably be suitable for example for the edge strengthening structure 106 made of the polymer-based adhesive, the tape-based material, or the 3D printable plastic. In this example after the producing the edge strengthening structure 106, the manufacturing method may continue to the cutting step, where the combined structure comprising at least the carrier 101, the etch stop layer 102, the foil structure 103, and the edge strengthening structures 106 may be cut into the pieces as discussed above.

FIG. 4D illustrates yet another example of producing the edge strengthening structure 106. In the example of FIG. 4D the edge strengthening structure 106 may be produced on the single piece on the opposite side of the foil structure 103 than the etch stop layer 102 after cutting the combined structure comprising at least the carrier 101, the etch stop layer 102, and the foil structure 103 into the pieces. The producing process of the edge strengthening structure 106 according to the example of FIG. 4D corresponds otherwise to the producing process of the edge strengthening structure 106 according to the example of FIG. 4C, but the edge strengthening structure 106 is produced on the single chip after the cutting step. In this example after the producing the edge strengthening structure 106, the manufacturing method may continue to the attaching step, where the combined structure comprising the carrier 101, the etch stop layer 102, the foil structure 103, and the edge strengthening structure 106 is attached to the housing 105 as discussed above. Alternatively, the at least part of the carrier 101 may be detached (e.g. etched away) before attaching the combined structure comprising at least the etch stop layer 102, the foil structure 103, and the edge strengthening structure 106 and possibly also the additional support structure 101a formed by the remaining part of the carrier 101 to the region 202 around the opening 104 in the housing 105.

FIG. 4E illustrates yet another example of producing the edge strengthening structure 106. In the example of FIG. 4E the edge strengthening structure 106 may be produced on the edge region 201 around the opening 104 in the housing 105. The edge strengthening structure 106 may be produced on the edge region 201 around the opening 104 in the housing 105 similarly as any of the example producing processes discussed above referring to FIGS. 4A-4D, but instead of producing the edge strengthening structure 106 on the foil structure 110 the edge strengthening structure is produced on the housing 105.

FIG. 4F illustrates yet another example of producing the edge strengthening structure 106. In the example of FIG. 4F the edge strengthening structure 106 may be produced at least partly inside the foil structure 103. For example, the edge strengthening structure 106 may be produced at least partly inside the at least one thin film layer 103a and/or the at least one radiation filtering layer 130b. In the example of FIG. 4F, the edge strengthening structure 106 is produced completely inside the foil structure 103, i.e. between a thin film layer 103a and a radiation filtering layer 103b of the foil structure 103, but the invention is not limited to that. In the example of FIG. 4F the edge strengthening structure 106 may be produced on the opposite side of the thin film layer 103a than the etch stop layer 102 before producing the foil structure 103 on the etch stop layer 102. In this example the producing of the edge strengthening structure 106 may comprise depositing a strengthening film 106a on the opposite side of the thin film layer 103a than the etch stop layer 102. The strengthening film 106a may for example be deposited by using one of the example deposition processes discussed above referring to the example of FIG. 4A. In the next step of the example of FIG. 4F the strengthening film 106a may be patterned to produce the annular shape of the edge strengthening structure 106 from the strengthening film 106a. The patterning of the strengthening film 106a may for example be performed by using one of the example patterning processes discussed above referring to the example of FIG. 4A. In the example of FIG. 4F after the producing the edge strengthening structure 106, the radiation filtering layer 103b may be produced on the thin film layer 103a so that the edge strengthening structure 103 remains at least partly inside the radiation filtering layer 103b of the foil structure 103. After producing the radiation filter layer 103b, the manufacturing method may continue to the cutting step, where the combined structure comprising at least the carrier 101, the etch stop layer 102, the foil structure 103, and the edge strengthening structure(s) 106 may be cut into the pieces as discussed above. In the example of FIG. 4F only one example process for producing the edge strengthening structure 106 at least partly inside the foil structure 103 is illustrated, but the invention is not limited to that, and the edge strengthening structure 106 may also be produced at least partly inside the foil structure 103 by using any other producing process. For example, the producing processes discussed above referring to FIGS. 4B-4D may be applied also, when the edge strengthening structure 106 is produced at least partly inside the foil structure 103, but instead of producing the edge strengthening structure 106 on the opposite side of the foil structure 103, the edge strengthening structure 106 is produced at least partly inside the foil structure 103.

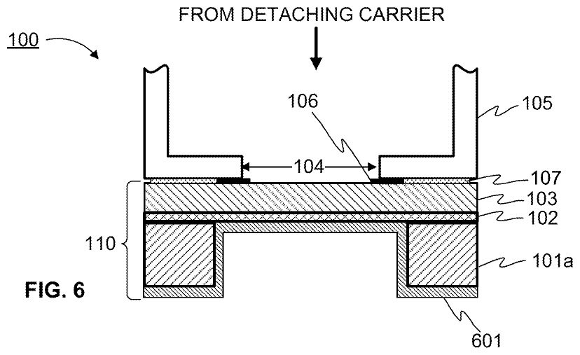

FIG. 6 illustrates an optional addition that may be added to any of the example methods described above. In the example according to FIG. 6 an additional radiation filtering layer 601 is produced at least on the exposed etch stop layer 102 after the detaching the at least part of the carrier 101. FIG. 6 illustrates a cross-sectional view of the workpiece in the example step of producing the additional radiation filtering layer 601. The additional radiation filtering layer 601 may for example be, but is not limited to, made of aluminium, zirconium, niobium, or silver. The additional radiation filtering layer 601 may be produced on the exposed etch stop layer 102 and on the annular additional support structure 101a formed by the remaining part of the carrier 101, after detaching the carrier 101 partly as illustrated in the example of FIG. 6. Alternatively, the additional radiation filtering layer 601 may be produced only on the exposed etch stop layer 102 (not on the annular additional support structure 101a formed by the remaining part of the carrier 101) after the detaching the carrier 101 partly. Alternatively, the additional radiation filtering layer 601 may be produced on the exposed etch stop layer 102 after the detaching the whole carrier 101. The additional radiation filtering layer 601 has a role in blocking out unwanted wavelengths of electromagnetic radiation, such as visible light, IR radiation, and/or UV radiation, etc.

Advantages of the invention include the possibility of manufacturing radiation windows for X-ray measurement apparatuses, where the radiation window foil is very thin and yet gastight, absorbs very little X-rays, and has good tensile strength also when mounted on the housing of the radiation window 100.

The specific examples provided in the description given above should not be construed as limiting the applicability and/or the interpretation of the appended claims. Lists and groups of examples provided in the description given above are not exhaustive unless otherwise explicitly stated.

1. A method for manufacturing a radiation window for an X-ray measurement apparatus, the method comprises:
producing an etch stop layer on a surface of a carrier;
producing a foil structure on an opposite side of the etch stop layer than the carrier, wherein the foil structure comprises at least one thin film layer; and
attaching a combined structure comprising at least the etch stop layer and the foil structure to a region around an opening in a housing with the foil structure facing the housing so that an edge strengthening structure is arranged between the combined structure and an edge region around the opening in the housing or at least partly inside the foil structure;
detaching at least part of the carrier before attaching the combined structure; or
detaching at least part of the carrier after attaching the combined structure, wherein the combined structure further comprises the carrier.

2. The method according to claim 1, wherein the edge strengthening structure comprises one or more of the following: a photo definable material, a polymer material, a polymer-based adhesive, a tape-based material, a 3D printable plastic, or a metal.

3. The method according to claim 1, arranging the edge strengthening structure to overlap with the opening.

4. The method according to claim 1, wherein the arranging the edge strengthening structure between the combined structure and the edge region around the opening in the housing comprises producing the edge strengthening structure:
on an opposite side of the foil structure than the etch stop layer, or
on the edge region around the opening in the housing.

5. The method according to claim 1, wherein the at least one thin film layer of the foil structure comprises one of the following: boron carbide, graphene, beryllium, polyimide, silicon nitride, or polycrystalline silicon.

6. The method according to claim 1, wherein the foil structure further comprises at least one radiation filtering layer.

7. The method according to claim 1, further comprising producing an additional radiation filtering layer at least on the etch stop layer after the detaching the at least part of the carrier.

8. A radiation window for an X-ray measurement apparatus, wherein the radiation window comprises:
a housing that defines an opening;
a radiation window foil attached to the housing at a region around the opening to cover the opening of the housing, wherein the radiation window foil comprises:
a foil structure comprising at least one thin film layer, wherein the foil structure is facing the housing, and
an etch stop layer on an opposite side of the foil structure than the housing; and
an edge strengthening structure arranged between the radiation window foil and an edge region around the opening in the housing or at least partly inside the foil structure.

9. The radiation window according to claim 8, wherein the edge strengthening structure comprises one or more of the following: a photo definable material, a polymer material, a polymer-based adhesive, a tape-based material, a 3D printable plastic, or a metal.

10. The radiation window according to claim 8, wherein the edge strengthening structure overlaps with the opening.

11. The radiation window according to claim 8, further comprising an additional support structure on an opposite side of the etch stop layer than the foil structure.

12. The radiation window according to claim 8, wherein the at least one thin film layer of the foil structure comprises one of the following: boron carbide, graphene, beryllium, polyimide, silicon nitride, or polycrystalline silicon.

13. The radiation window according to claim 8, wherein the foil structure further comprises at least one radiation filtering layer.

14. The radiation window according to claim 8, further comprising an additional radiation filtering layer on an opposite side of the etch stop layer than the foil structure.
